(19) United States
(12) Patent Application Publication
(10) Pub. No.: US 2004/0042641 A1
(43) Pub. Date: Mar. 4, 2004

(54) Personnel identity verification system

(76) Inventor: Peter Joel Jakubowski, Huntington Beach, CA (US)

Correspondence Address: Bruce B. Brunda, STETINA BRUNDA GARRED & BRUCKER, Suite 250, 75 Enterprise, Aliso Viejo, CA, 92656, US

(21) Appl. No.: 10/231,589

(22) Filed: Aug. 30, 2002

(51) Int. Cl. G06K 9/00

(52) U.S. Cl. 382/115

(57) ABSTRACT

A system for verification of personnel identity is provided. The system comprises an identity card retainable by a verifiee and having first data comprising an incomplete image of the verifiee stored thereon, a reading device operative to read the first data from the identity card, a database having second data comprising a remainder image combinable to produce a complete image of the verifiee stored therein, a processor operative to combine the first and second data to thereby combine the incomplete and remainder images in order to generate the complete image, and a monitor operative to display the complete image to allow the verifior to verify that a person presenting the identity card is the verifiee.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates generally to systems for verifying personnel identity, and more particularly to a system for verifying personnel identity in an secure manner by dividing an image of a person used to verify him between himself and a verifying entity, so that the image cannot be compromised either by the person or the verifying entity.

The ability to accurately and conveniently verify personnel identity has been a need felt by business and government organizations for a long time. In recent times, the need has been felt especially strongly due to a variety of factors. As the world becomes increasingly interconnected and accordingly more anonymous, the number of business interactions between persons entirely unfamiliar with each other increases. Theft of assets has been a problem since time immemorial, and shows no signs of vanishing. In particular, the advent of the information age and the increasing worth of intellectual property to corporate organizations has resulted in an associated rise in high-tech industrial espionage. The rise of global terrorism has also been of particular concern to the world community, and has put new steam into the ongoing effort to continually devise new and improved systems of personnel identity verification.

A variety of systems of varying levels of security and practicality have so far been devised. An example of an especially secure variety of system used in some applications is the biometric scanning device. A biometric scanning device scans a physiological feature of a person whose identity is to be verified, such as a fingerprint or iris pattern. Such physiological features are unique to each person, and are difficult to duplicate. A database of known persons' physiological features can be stored. The feature of the person to be identified is matched to the appropriate known person's feature stored in the database, and the person's identity verified thereby.

While it is difficult to fake a person's physiological features, it is not impossible. Since comprehensive data regarding the physiological feature is available either from the person himself or the database used by the scanning device, the technical difficulty of duplicating the person's physiological features is the only obstacle to deception. Unfortunately, as technology increases, achieving duplication becomes easier and easier.

Perhaps more importantly, however, the practical realities of the business world make the use of a biometric scanning device, as well as many other high security devices, entirely impracticable. In the business world, interactions are often sporadic. A delivery person delivers a package once and is never seen again. Unfamiliar representatives of other companies come, do their business, and leave on a regular basis. It is not a logistically realistic proposal to create a database of all these persons' physiological features and perform a verification test using the database each time one of the persons arrives.

A much more common, informal system of verification in the business world is simply to ask for a business card. If a person claiming to be a representative of a certain company presents a business card, an employee at least knows that the person is not a casual intruder. The level of security achieved by this system is obviously very low, however, since business cards are easy to fake. Also, an intruder can simply steal a business card and claim he is the person identified on the card.

In another form of identity verification, a person carries a photographic identification card with a photograph of himself printed thereon. A typical example of this form of identification is a state driver's license. Information about the person is printed on the card near his photograph. A verifying personnel can compare the photograph to the person's face, and if they match, the printed information is assumed to pertain to the person presenting the card.

Identity cards of this variety are more secure than business cards, but still provide a relatively low level of security. The card can be faked with the appropriate equipment. For instance, a legitimate card may be stolen, and the photograph thereof replaced with a photograph of an intruder. As long as the intruder is able to acquire a faked card, he will also be able to get past the verification system. An enterprising intruder can even steal a card of a person to whom he appears similar, and pass himself off as that person.

A variation upon the above system is to use a database accessible by the verifying entity instead of identity cards. The database consists of images of known persons and their names. A person can simply give his name, and the verifying entity looks up the image associated with that name. If the image matches the person's appearance, then the person is assumed to be the known person who is represented by the image.

This system has the advantage that since the database is presumably more secure than widely issued identity cards, the data used for verification purposes is harder to falsify. Moreover, the inconvenience of carrying cards is eliminated. However, it is still possible for an intruder to find a person in the database to whom he appears similar, and pass himself off as that person. As noted above, the data on the card can also include the person's name. The name can then be inputted during the reading process into a visitor's register. This register, along with keeping track of the visitor until they leave, will also allow the customer's employees to leave a message for the visiting person that a meeting has been requested. It would also be possible for the employee to check at any time to determine if the visitor were at the facility in real-time.

The database could be combined with a photographic identification card as described above for additional security. In this case, an intruder would be forced to fake an identification card as well as pass himself off as a person in the database. An additional level of security is therefore provided, but an intruder willing to take the time to do both of these things can still beat the system.

More advanced systems use identification cards which store encrypted information translatable into a photograph or other identification measure by a computer. Such systems are more advanced than either a business card or simple photographic identification card, but it is still possible to break the encryption and fake a card using the broken encryption. Moreover, the encryption aspects of the card can render it expensive to produce.

It will be recognized that the above described systems suffer, in addition to their respective individual drawbacks, from the common drawback that the information used for identification purposes is compromisable at at least one end of the system. In this regard, faking of any necessary cards or similar devices of the security system is possible as long as an intruder has access to an appropriate one of the ends of the system.

Accordingly, there is a need to devise a personnel identity verification system free of this problem. Verification data to be used therein should be uncompromisable at either the end of the person whose identity is to be verified, or the end of the entity performing the verification. The system should ideally be implementable in a low cost form in order to facilitate use in situations involving a high volume of sporadic interactions between unknown persons, as in many business environments.

### BRIEF SUMMARY OF THE INVENTION

In accordance with the present invention, a system for verification of personnel identity is provided. The system comprises an identity card retainable by a verifiee and having first data comprising an incomplete image of the verifiee stored thereon. The system also comprises a reading device communicatable with the identity card and operative to read the first data from the identity card. The system further comprises a database having second data comprising a remainder image combinable to produce a complete image of the verifiee stored therein. The complete image may be a facial image, fingerprint image, iris pattern image, or the like. The system still further comprises a processor in communication with the database and the reading device. It is operative to combine the first and second data to thereby combine the incomplete and remainder images in order to generate the complete image. The system additionally comprises a monitor in communication with the processor and viewable by a verifior. It is operative to display the complete image to allow the verifior to verify that a person presenting the identity card is the verifiee.

The complete image may be a facial image, fingerprint image, iris pattern image, or the like. The system comprises any necessary further components in this regard. Likewise, a variety of storage and reading devices can be used, including magnetic storage media and readers, holographic storage media and readers, infrared transmitters and receivers, or even a graphical scanner used in conjunction with images printed directly onto the identity card.

In a simplified version of the present invention, the identity card comprises a transparency sheet, onto which the incomplete image is printed directly. The monitor in this embodiment is operative to display the incomplete image instead of the complete image. The verifior may simply hold the transparency sheet up to the monitor, placing it over a target area in which the incomplete image is displayed, to thereby produce the complete image. The embodiment has the advantage of being implementible at an extremely low cost, since only low cost materials and common devices are used. It is therefore suitable for applications involving high amounts of traffic involving single time visitors.

In the case of either the advanced or the simplified version, the entirety of the complete image is not compromisable at either end of the system. Because neither the verifiee nor the verifior has the ability to disclose the entire complete image, the system provides a relatively high level of security without the need for conventional encryption technology.

In the case of the simplified embodiment, division of the complete image into the incomplete and remainder images may be accomplished simply by segmenting the same. In the case of the more advanced version, a wider variety of techniques are available. For instance, the complete image may be divided by dividing a plurality of pixels composing the complete image between the incomplete image and remainder image. The missing pixels in the incomplete and remainder images may simply be replaced with pixels of a reserved color, such as black. Alternatively, the missing pixels in the incomplete image can be replaced with noise pixels having random color values. This ensures that if the first data is compromised, an intruder's access to the important portion of the incomplete image is impeded. The noise pixels can simply be replaced with the corresponding pixels in the remainder image when the two are combined. In order to ensure that the noise pixels are indistinguishable from the actual data pixels in the incomplete image, their color distribution may be similar to the color distribution of the actual data pixels.

As an alternative to the use of noise pixels, the pixels of the incomplete image may be stored as an undelimited string of pixels. An intruder acquiring access thereto will be unable to tell where in the complete image the pixels belong. The pixels may simply be inserted in series into their respective positions in the remainder image during combination of the images.

As an alternative to dividing the pixels of the complete image between the incomplete and remainder images, division may be accomplished by means of dividing color values of its pixels between respective pixels of the incomplete and remainder images. A randomization function can be used to split the color values so that the differences vary, in order to prevent the process from producing a merely color shifted version of the complete image.

Encryption techniques may be used to further protect the first data, second data, or first and second data in common. The first and second data taken together can also comprise passwords or dates. Such items may of course be divided between the first and second data, just as the complete image is divided. Dates can be used in conjunction with corresponding passwords in order to provide an even higher level of security.

When used with disposable identity cards, the system may be configured to remove the second data from the database after verification is accomplished, in order to prevent a single identity card from being used more than once.

Various further modifications are possible. The identity card can comprise two separate storage medium responsible for storing different parts of the first data. Further modifications will be apparent to those of ordinary skill in the art.

### BRIEF DESCRIPTION OF THE DRAWINGS

FIG. 1 illustrates the basic functionality of the system of the present invention in block diagram format.

FIG. 2 illustrates devices of an embodiment in accordance with the basic system.

FIG. 3 depicts a simplified, low cost embodiment of the present invention in which the identity card has a transparency sheet onto which the incomplete image is printed.

FIG. 4a illustrates a method for dividing a complete image by dividing pixels thereof between an incomplete and remainder image.

FIG. 4b illustrates how the incomplete image may further comprise noise pixels.

FIG. 4c illustrates how the incomplete image may consist exclusively of an undelimited string of pixels.

FIG. 5 illustrates an alternative method of dividing the complete image into incomplete and remainder images.

FIG. 6 illustrates an alternative embodiment of the identity card in which two storage media are used.

### DETAILED DESCRIPTION OF THE INVENTION

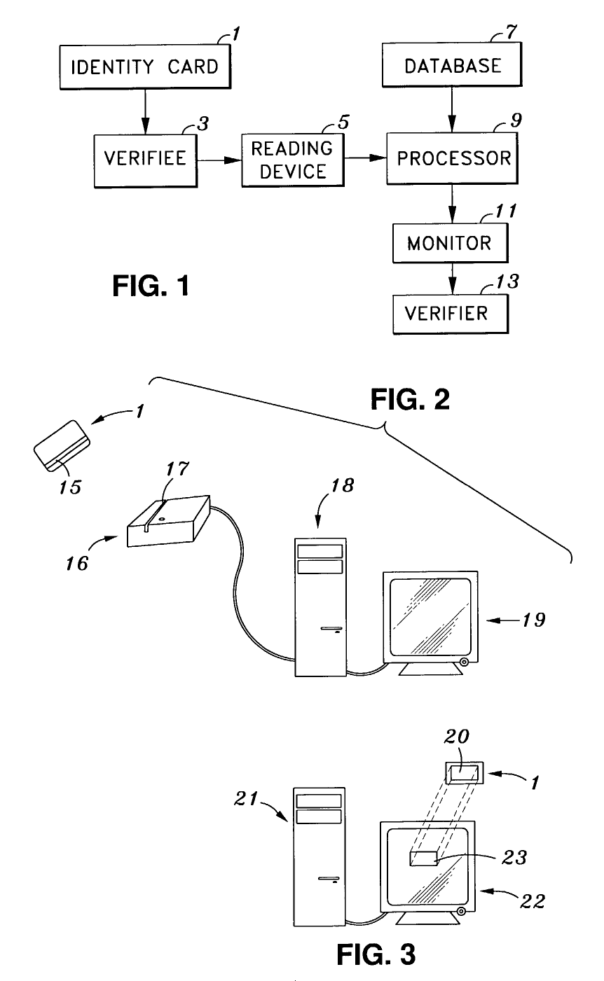

Referring now to FIG. 1, the basic system of the present invention is illustrated in block diagram format. The system comprises an identity card 1. The identity card 1 is retainable by a verifiee 3, and has first data stored thereon. The first data comprises an incomplete image of the verifiee.

The system further comprises a reading device 5 communicatable with the identity card 1. Communication between the identity card 1 and reading device 5 may be established by any appropriate means. In the embodiment depicted, the verifiee 3 presents the identity card 1 to the reading device 5. In any event, the reading device 5 is operative to read the first data from the identity card 1.

The system further comprises a database 7 having second data stored therein. The second data comprises a remainder image which is combinable with the incomplete image to produce a complete image of the verifiee. In other words, data of which the complete image consists is divided between the first data stored on the identity card 1 and the second data stored in the database 7. The database can be stored in a remote location accessible through the internet. In the preferred embodiment of the present invention, the complete image is a facial image of the verifiee's face.

The system further comprises a processor 9 in communication with the database 7 and the reading device 5. The processor 9 is operative to combine the first and second data to thereby combine the incomplete and remainder images. The processor 9 thereby generates the complete image.

The system further comprises a monitor 11 in communication with the processor 9. The monitor 11 is viewable by a verifior 13. The monitor 11 is operative to display the complete image to allow the verifior to verify that a person presenting the identity card is the verifiee. As described above, in the preferred embodiment the complete image is a facial image. The verifior may therefore accomplish verification by simply comparing the complete image to the appearance of the person presenting the identity card, in order to make sure that he is the person shown on the card. However, more advanced implementations wherein the complete image is an image of a fingerprint, iris pattern, or similar distinguishing feature of the verifiee are also possible. In such a case, the system further comprises additional equipment operative to read such distinguishing feature of the verifiee and compare it to the complete image.

The devices of an embodiment in accordance with the basic system described above are shown in FIG. 2. The identity card 1 of this embodiment comprises a magnetic strip 15. The magnetic strip 15 is used to store the first data with the incomplete image therein in digital format. The reading device of this embodiment is a magnetic strip reader 16. The magnetic strip reader 16 comprises a slot 17 through which the identity card 1 may be passed. When the identity card 1 is passed through the slot 17, the magnetic strip reader 16 reads the first data on the magnetic strip 15 and sends it to a processor comprised by a personal computer 18. The computer 18 also comprises a hard drive on which is stored the database having the second data and remainder image therein. The processor calls up the second data and combines it with the first data. In this regard, the processor combines the incomplete image and the remainder image to produce the completed image. The complete image is displayed on a monitor 19 for viewing by a verifior, who can look at the complete image and compare it to the appearance of a person presenting the identity card 1. If the complete image depicts the person presenting the identity card 1, then the result of the verification check is positive. If not, appropriate defensive action can be taken.

While the above described embodiment employs a magnetic strip disposed on the identity card and a magnetic strip reader, it is understood that a variety of storage and reading devices might be used. For instance, the identity card could comprise a holographic storage medium, and the reading device could correspondingly comprise holographic reading device as known in the art. Likewise, the identity card could comprise a card memory in which the first data is stored and an infrared transmitter in communication therewith, operative to transmit the first data. In this case, the reading device comprises an infrared receiver. Furthermore, the first data could be printed directly onto the identity card in graphical format and a graphical scanner comprised by the reading device utilized to accomplish reading thereof. It is understood that this embodiment of the present invention may be used in conjunction with a variety of storage and reading methods and systems as known in the art.

The above described system may be simplified in order to create a low cost version, such as is depicted in FIG. 3. The system still comprises an identity card 1 retainable by a verifiee. In this embodiment, however, rather than having digital storage means, the identity card 1 comprises a transparency sheet 20. An incomplete image of the verifiee is printed directly thereon.

The system further comprises a database having data stored therein, which may be stored on the hard drive of a personal computer 21. The data is analogous to the second data of the more advanced system above and comprises the remainder image combinable with the incomplete image to produce a complete image of the verifiee.

The system further comprises a monitor 22 in communication with the database, for instance by way of a processor of the personal computer 21. The monitor 22 is viewable by a verifior. The monitor 22 is operative to display the remainder image so that the complete image is created if the verifior transposes the transparency sheet 20 of the identity card 1 against the monitor 7. In this regard, the monitor 22 may be configured to display the remainder image in a target zone 23 of similar shape and size to the transparency sheet 20. In practice, the verifior simply holds the identity card 1 up against the monitor 22 so that the transparency sheet 20 is positioned over the target zone 23. The result is the creation of the complete image. The verifior can view the complete image and compare it to an appearance of the personnel.

It will be appreciated that the system described above can be implemented at a relatively low cost. A normal personal computer is used to store the database and a standard monitor is used as the display device. The identity card 1 can be made of low cost plastic materials. Data storage thereon is accomplished by simply printing the data in graphical format directly onto the transparency sheet, which can be accomplished with many ordinary printers. Segmenting of the complete image may be performed by software of the personal computer. As a result of the low cost of this system, it is suitable for use in applications where a high volume of sporadic traffic is anticipated. In particular, since the identity card of this embodiment may be produced at low cost, it is possible to produce a large number of disposable identity cards in an economical fashion.

It will be appreciated that in the case of either the advanced or the simplified version of the present invention as disclosed above, the entirety of the data used to verify the verifiee, namely the complete image, is not compromisable at either end of the system. Specifically, neither the verifiee nor the verifior has the ability to disclose the entirety of the complete image. As a result, the system provides a relatively high level of security, without the need for any type of conventional encryption technology.

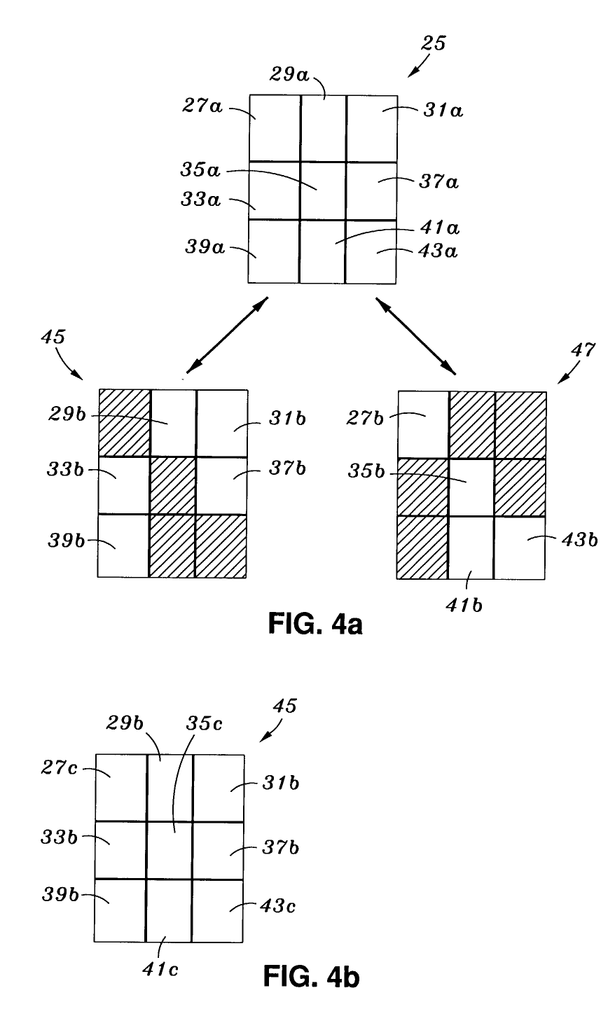

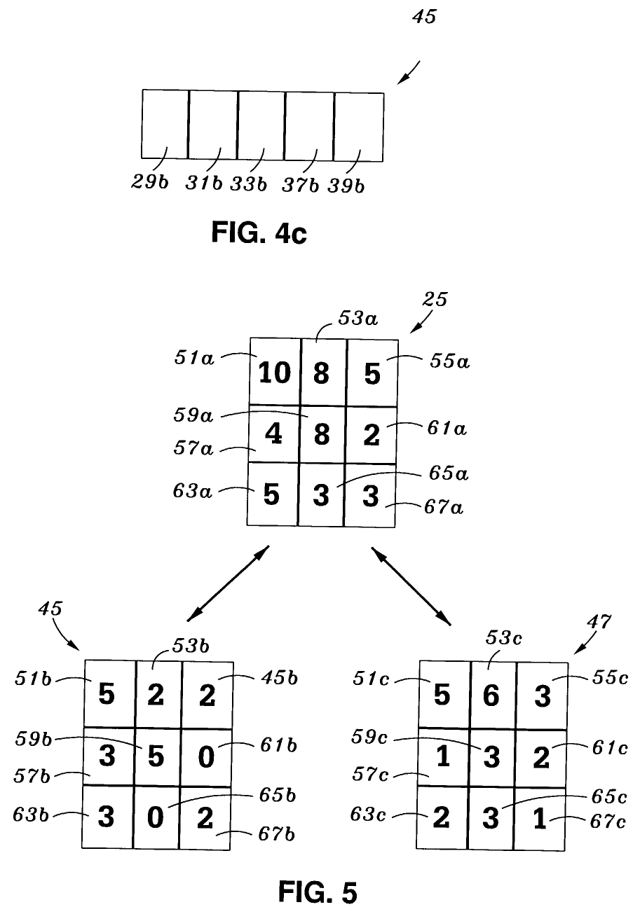

In the case of the simplified embodiment of the present invention disclosed above, division of the complete image into the incomplete and remainder images can be accomplished by simply segmenting the complete image. In comparison, digital storage of the first data and incomplete image therein, as in the more advanced embodiment described further above, allows a wide variety of techniques to be employed to divide an original complete image into an incomplete image and remainder image. One such technique is illustrated in FIG. 4a. The complete image 25 is composed of a plurality of pixels 27a-43a. The plurality of pixels 27a-43a is divided between an incomplete image 45 and a remainder image 47.

It is understood that the pixels are represented graphically in the drawings in order to facilitate better understanding of the methods described below. In reality, the pixels are, of course, stored in digital format. Moreover, while nine pixels 27a-43a are shown for clarity's sake, the complete image 25 would typically comprise a great many more pixels. In this regard, it may be imagined that each of the complete image 25, incomplete image 45, and remainder image 47 are each shown in part only.

The incomplete image 45 can be seen to comprise an incomplete portion 29b,31b,33b,37b,39b of the plurality of pixels 27a-43a. In this regard, the incomplete image 45 comprises a subset of pixels corresponding to respective ones of the plurality of pixels 27a-43a. In practice, any of the plurality of pixels 27a-43a not corresponding to a one of the subset of pixels may simply be replaced by pixels of a reserved color, such as black.

The remainder image 47 correspondingly comprises a remaining portion 27b,35b,41b,43b of the plurality of pixels 27a-43a, or in other words also comprises a subset of pixels corresponding to respective ones of the plurality of pixels 27a-43a. It is immediately apparent upon comparison of the incomplete image 45 and remainder image 47 that the incomplete portion 29b,31b,33b,37b,39b and remaining portion 27b,35b,41b,43b together compose a set of pixels corresponding to each and every one of the plurality of pixels 27a-43a. Hence, when the first data comprising the incomplete image 45 and the second data comprising the remainder image 47 are combined, the two images are combined in order to recreate the complete image 25.

Referring now to FIG. 4b, it is shown how the incomplete image 45 may further comprise noise pixels 27c,35c,41c,43c in addition to the incomplete portion 29b,31b,33b,37b,39b of pixels. Respective ones of the noise pixels 27c,35c,41c,43c stand in place of respective ones of the remaining portion 27b,35b,41b,43b (FIG. 4a), and have randomly assigned colors. Addition of the noise pixels 27c,35c,41c,43c has the advantage that the incomplete image 45 comprises an indistinguishable mixture of pixels useful to create the complete image, and pixels having no data significance whatsoever. If an intruder acquires the identity card on which the first data having the incomplete image 45 is stored, he will be able to access a number of pixels adequate to form an image of the same size as the complete image. However, he will be unable to determine which of those pixels compose the incomplete portion of pixels 29b,31b,33b,37b,39b and which of them pixels are merely noise pixels 27c,35c,41c,43c. His ability to access the incomplete portion of pixels 29b,31b,33b,37b,39b is thereby impeded. In practice, when the incomplete image 45 is combined with the remainder image, the noise pixels 27c,35c,41c,43c are simply replaced with the remaining portion of pixels.

As stated above, the color values of the noise pixels 27c,35c,41c,43c may be randomly assigned. However, the color values need not be randomly assigned in such a fashion as to produce a color distribution of the noise pixels 27c,35c,41c,43c in which each available color occurs with substantially the same frequency. This may be undesirable because in real images, depending upon the subject of the image, certain colors occur with dramatically higher frequency than others. Therefore, an intruder able to access the incomplete image 45 might also be able to determine which of the pixels were noise pixels 27c,35c,41c,43c by determining which pixels fell outside an expected range of colors. Accordingly, the color values of the noise pixels 27c,35c,41c,43c may instead by randomized in such a fashion as to produce a first color distribution thereof substantially similar to a second color distribution of the incomplete portion 29b,31b,33b,37b,39b of pixels. This can be accomplished by applying appropriate parameters to the randomization function, and will eliminate the aforementioned problem.

Referring now to FIG. 4c, an alternative security measure of comparable utility to the measure described immediately above is shown. It can be seen therein that the incomplete image 45 consists exclusively of an undelimited string of the incomplete portion 29b,31b,33b,37b,39b of pixels. In this regard, the incomplete image 45 does not comprise any pixels corresponding to respective ones of the remaining portion of pixels. If an intruder gains access to the incomplete image 45, he will have ready access to all of the incomplete portion 29b,31b,33b,37b,39b of the pixels. However, because they are presented in an undelimited string, it is impossible to determine where they belong in the complete image. As a result, it is impossible for the intruder to reconstruct any useful representation of the incomplete image 45. In practice, each of pixel of the incomplete portion 29b,31b,33b,37b,39b may simply be used in sequence to fill missing pixels of the remainder image.

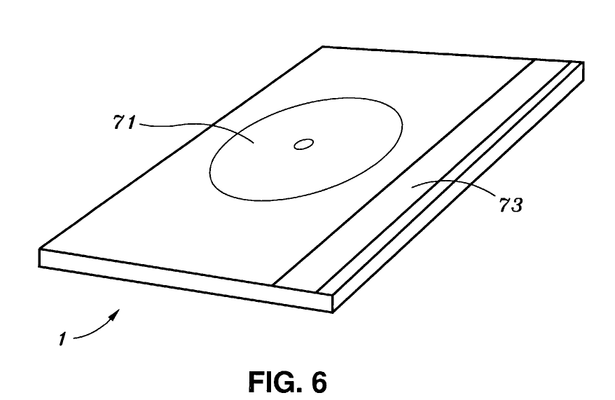

Referring now to FIG. 5, an alternative method of dividing an original complete image into an incomplete image and a remainder image is shown. It can be seen therein that the complete image 25 is composed of a first plurality of pixels 51a-67a. The first plurality of pixels 51a-67a have first color values, shown as numerals printed thereupon. The color values are representative of colors of the pixels, with each possible value representing one color in the range of available colors. While the color values are shown as numerals with a maximum value of ten for the sake of clarity, it is understood that the color values would typically have a much greater range, as the first plurality of pixels 51a-67a would typically represent a much wider variety of colors than only ten colors.

The complete image 25 is divided into an incomplete image 45 and remainder image 47, as in the previous embodiment. However, the plurality of pixels 51a-67a are not divided between the two images. Instead, the first color values thereof are divided between the two images. In this regard, the incomplete image 45 is composed of a second plurality of pixels 51b-67b having second color values, and the remainder image 47 is composed of a third plurality of pixels 51c-67c having third color values. Sums of respective ones of the second and third color values are equal to respective ones of the first color values. In other words, if the color value of a pixel of the incomplete image 45 is added to the color value of a respective pixel of the remainder image 47, the sum is the color value of a respective pixel of the complete image 25. For instance, the color value of pixel 51b, five, added to the color value of pixel 51c, five, equals the color value of pixel 51a, ten. In this regard, it may be imagined that the colors of the complete image 25 are “divided” between the incomplete image 45 and remainder image 47. Of course, the differences imposed should vary as between various pixels of the complete image 25, or the image will merely be color shifted. A randomization function can be used to this end. It is also worth nothing that the scale of color values may “wrap.” In other words, summed values which exceed the maximum possible color value may begin again at the bottom of the color value scale.

Traditional encryption techniques can be used in order to make the basic system even more secure. For instance, the first data may be encrypted. If so, the processor is further operative to decrypt the first data prior to combination with the second data. Likewise, the second data may be encrypted, and the processor further operative to decrypt the second data prior to combination with the first data. Moreover, the first and second data may be encrypted commonly. Depending on the encryption type, this may render it impossible to decrypt the first or second data alone. The processor is in this case operative to decrypt the first and second data subsequent to combination.

As an additional security measure, a data set consisting of the first and second data may comprise at least one password. In this case, the monitor is further operative to display the at least one password subsequent to combination of the first and second data by the processor. For instance, the first or second data might individually comprise the password in question. After making a visual inspection of the verifiee and comparing his appearance to the complete image, the verifior may ask the verifiee for the password. If the verifiee knows the password, then his identity is further assured. If he does not know the password, his identity is cast into doubt. Of course, the method described above for dividing information into separate parts to prevent compromise of the information at either end of the system may also be employed with respect to the at least one password. In this regard, the at least one password may be comprised incompletely by the first data and remainingly by the second data.

As an alternative or in addition to the use of a password, the data set consisting of the first and second data may comprise at least one date. If so, the monitor is further operative to display the at least one date subsequent to combination of the first and second data by the processor. The date can be a date on which the person depicted in the incomplete image is expected to arrive. If the verifiee arrives on one of the at least one dates comprised by the data set, then his identity is further assured. Conversely, if he arrives on a date which is not one of the at least one dates comprised by the data set, his identity is cast into doubt. Of course, the at least one date may be comprised incompletely by the first data and remainingly by the second data in the same fashion as the at least one password described above.

The use of at least one password and use of at least one date may, of course, be combined. In one such embodiment, a one of the first and second data comprises the at least one date, and an other of the first and second data comprises an at least one password corresponding to the at least one date. The monitor is further operative to display the at least one password subsequent to combination of the first and second data by the processor. In this regard, a password may be associated with a date. The processor may comprise an internal clock, and the monitor be operative to display the password associated with the current date. The verifiee is required to know this password in order to establish his identity. The password may therefore be date specific, and accordingly the verifiee may be required to give a different password upon each different date.

If the system is used in an application in which a large volume of single arrival personnel are expected to need identity verification, the system may be made more secure by configuring the processor to automatically remove the second data from the database after the monitor displays the complete image. In this regard, the system may be configured in such a way that verification of a person results in the immediate destruction of a portion of the verification data. As a result, it will be impossible for an intruder to pass himself off as the person subsequent to the genuine person's arrival, or for the person himself to use his identity card to make a second, unauthorized visit.

The system may be modified in various ways to provide further functionality. Referring to FIG. 6, an alternate embodiment of the identity card 1 is shown. In this embodiment, the identity card 1 comprises both an optical disc 71 as a first storage medium and a magnetic strip 73 as a second storage medium. The optical disc is used to store a first portion of the first data. The first portion consists of the incomplete image. The second storage medium is used to store a second portion of the first data. The second portion consists of any remainder of the first data.

In this regard, the magnetic strip 73 may be used to store any part of the first data other than the incomplete image. For instance, the magnetic strip 73 could be used to store a unique identifier respecting an identity of the second data. The unique identifier can be a file name, serial number, or the like. The reading device must correspondingly comprise two separate reader elements, each of which is responsible for accomplishing reading of one of the two storage media. Once the unique identifier is read from the magnetic strip 73, it can be used by the processor to reference the second data for combination with the first data stored on the optical disc 71. The database can be internet connected. In this way, sporadic data is not necessarily stored at the user's site. The data can be constantly updated by the company being represented. Should the employee-company relationship be terminated, the remainder data at the Amano web site could be modified to withhold verification. Also, as a service, the company could be appraised of any use of the identity card. Not only does this provide added security, but the company can be assured that their employee actually visited the facilities claimed.

A variety of further modifications will be apparent to those of ordinary skill in the art. For instance, the first data and second data could obviously comprise a wide variety of additional information. Such additional information might include the name of the person associated with the complete image, birth dates, employee identification numbers, physical descriptions, and the like. It is understood that such embodiments are intended to be within the spirit and scope of the present invention.

I claim:

1. A personnel identity verification system comprising:
a. an identity card retainable by a verifiee having first data stored thereon, the first data comprising an incomplete image of the verifiee;
b. a reading device communicatable with the identity card, operative to read the first data from the identity card;
c. a database having second data stored therein, the second data comprising a remainder image combinable with the incomplete image to produce a complete image of the verifiee;
d. a processor in communication with the database and the reading device, operative to combine the first and second data to thereby combine the incomplete and remainder images, to thereby generate the complete image; and
e. a monitor in communication with the processor and viewable by a verifior, operative to display the complete image to allow the verifior to verify that a person presenting the identity card is the verifiee.

2. The system of claim 1, wherein the complete image is a facial image of a face of the verifiee.

3. The system of claim 1, wherein the complete image is a fingerprint image of at least one fingerprint of the verifiee.

4. The system of claim 1, wherein the complete image is an iris pattern image of at least one iris pattern of the verifiee.

5. The system of claim 1, wherein the identity card comprises a magnetic strip, the first data being stored thereon, and the reading device comprises a magnetic strip reader operative to scan the magnetic strip to thereby read the first data.

6. The system of claim 1, wherein the identity card comprises a holographic storage medium, the first data being stored thereon, and the reading device comprises a holographic reader operative to scan the holographic storage medium to thereby read the first data.

7. The system of claim 1, wherein the identity card comprises a card memory in which the first data is stored, and further comprises an infrared transmitter in communication therewith and operative to transmit the first data, and the reading device comprises an infrared receiver operative to receive the first data.

8. The system of claim 1, wherein the first data is printed graphically onto the identity card and the reading device comprises a graphical scanner operative to graphically scan the identity card to thereby read the first data.

9. A personnel identity verification system comprising:
a. an identity card retainable by a verifiee and comprising a transparency sheet, the transparency sheet having an incomplete image of the verifiee printed thereon;
b. a database having data stored therein, the data comprising a remainder image combinable with the incomplete image to produce a complete image of the verifiee; and
d. a monitor in communication with the database and viewable by a verifior, operative to display the remainder image so that the complete image is created if the verifior transposes the transparency sheet of the identity card against the monitor, to thereby allow the verifior to verify that a person presenting the identity card is the verifiee.

10. The system of claim 1, wherein the complete image is composed of a plurality of pixels, the incomplete image comprises an incomplete portion of the pixels, and the remainder image comprises a remaining portion of the pixels, the incomplete and remaining portions together composing the plurality of pixels.

11. The system of claim 10, wherein the incomplete image further comprises noise pixels having random colors, respective ones of the noise pixels standing in place of respective ones of the remaining portion of pixels.

12. The system of claim 11, wherein the random colors of the noise pixels are randomized in such a fashion as to produce a noise color distribution of the noise pixels substantially similar to a sample color distribution of the incomplete portion of the pixels.

13. The system of claim 10, wherein the incomplete image consists exclusively of an undelimited string of the incomplete portion of the pixels.

14. The system of claim 1, wherein the complete image is composed of a first plurality of pixels having first color values, the incomplete image is composed of a second plurality of pixels having second color values, and the remainder image is composed of a third plurality of pixels having third color values, wherein sums of respective ones of the second and third color values are equal to respective ones of the first color values.

15. The system of claim 1, wherein the first data is encrypted, and the processor is further operative to decrypt the first data prior to combination with the second data.

16. The system of claim 1, wherein the second data is encrypted, and the processor is further operative to decrypt the second data prior to combination with the first data.

17. The system of claim 1, wherein the first and second data are encrypted commonly, and the processor is further operative to decrypt the first and second data subsequent to combination.

18. The system of claim 1, wherein the processor is further operative to remove the second data from the database after the monitor displays the complete image.

19. The system of claim 1, wherein a data set consisting of the first and second data comprises at least one password, and the monitor is further operative to display the at least one password subsequent to combination of the first and second data by the processor.

20. The system of claim 19, wherein the at least one password is comprised incompletely by the first data and remainingly by the second data.

21. The system of claim 1, wherein a data set consisting of the first and second data comprises at least one date, and the monitor is further operative to display the at least one date subsequent to combination of the first and second data by the processor.

22. The system of claim 21, wherein the at least one date is comprised incompletely by the first data and remainingly by the second data.

23. The system of claim 1, wherein a one of the first and second data comprises at least one date, an other of the first and second data comprises at least one password corresponding to the at least one date, and the monitor is further operative to display the at least one password subsequent to combination of the first and second data by the processor.

24. A method of verifying the identity of a verifiee comprising:
a. dividing a complete image of the verifiee into an incomplete image and a remainder image;
b. combining the incomplete image and remainder image to reproduce the complete image; and
c. comparing the reproduced complete image to a person presenting the incomplete image to a verifior, the verifior having the remainder image, to determine whether the person is the verifiee.

25. The system of claim 1, wherein the identity card comprises a first storage medium, a first portion of the first data consisting of the incomplete image being stored thereon, and further comprises a second storage medium, a second portion of the first data consisting of any remainder of the first data being stored thereon.

26. The system of claim 25, wherein the first storage medium is an optical storage medium and the second storage medium is a magnetic storage medium.

27. The system of claim 25, wherein the second portion comprises a unique identifier respecting an identity of the second data, and wherein the processor is operative to access the second data by referencing the unique identifier to thereby discover the identity of the second data.
